(19) United States
(12) Patent Application Publication
(10) Pub. No.: US 2021/0191626 A1
(43) Pub. Date: Jun. 24, 2021

(54) DATA PROCESSING SYSTEM

(71) Applicant: SK hynix Inc., Icheon (KR)

(72) Inventors: Jun Hee RYU, Icheon (KR); Kwang Jin KO, Icheon (KR); Hyung Jin LIM, Icheon (KR)

(21) Appl. No.: 16/905,404

(22) Filed: Jun. 18, 2020

(30) Foreign Application Priority Data
Dec. 18, 2019 (KR) 10-2019-0169772

(51) Int. Cl. G06F 3/06

(52) U.S. Cl. CPC G06F 3/0613; G06F 3/0673; G06F 3/0659

(57) ABSTRACT

A data processing system includes a storage unit and an input/output unit. The input/output unit is configured to perform a read-ahead operation on first data stored in the storage unit according to a read-ahead size, perform a determination of whether the read-ahead operation causes a bottleneck with respect to a processing unit, and adjust the read-ahead size depending on a result of the determination.

### CROSS-REFERENCES TO RELATED APPLICATION

The present application claims priority under 35 U.S.C. § 119(a) to Korean application number 10-2019-0169772, filed on Dec. 18, 2019, in the Korean Intellectual Property Office, which is incorporated herein by reference in its entirety.

### BACKGROUND

### 1. Technical Field

Various embodiments generally relate to a data processing system, and more particularly, to a data processing system including a memory device.

### 2. Related Art

A data processing system may include a memory system and a host device. The memory system may be configured to store data provided from the host device, in response to a write request from the host device. Also, the memory system may be configured to provide stored data to the host device, in response to a read request from the host device.

### SUMMARY

Various embodiments of the disclosure are directed to a data processing system capable of efficiently performing a read-ahead operation.

In an embodiment, a data processing system may include: a storage unit; and an input/output unit configured to perform a read-ahead operation on first data stored in the storage unit according to a read-ahead size, wherein the input/output unit performs a determination of whether the read-ahead operation causes a bottleneck with respect to a processing unit, and adjusts the read-ahead size depending on a result of the determination.

In an embodiment, a data processing system may include: a storage unit; and an input/output unit configured to: store metadata in a memory when performing a read-ahead operation on first data stored in the storage unit, and perform a subsequent read-ahead operation on second data based on the metadata when a read request for the first data is received from a processing unit before the read-ahead operation is completed.

In an embodiment, a method for operating a data processing system including a storage unit and an input/output unit may include: performing a read-ahead operation on first data stored in the storage unit; and increasing a read-ahead size up to a size limited according to a read-ahead condition, the read-ahead size being increased up to a first maximum read-ahead size when a first read-ahead condition occurs, the read-ahead size being increased up to a second maximum read-ahead size larger than the first maximum read-ahead size when a second read-ahead condition occurs.

According to the embodiments of the disclosure, the data processing system may efficiently perform a read-ahead operation.

### BRIEF DESCRIPTION OF THE DRAWINGS

FIG. 1 illustrates a data processing system in accordance with an embodiment of the disclosure.

FIG. 2 illustrates operation of an input/output unit of FIG. 1 in accordance with an embodiment of the disclosure.

FIG. 3 illustrates operation of a read-ahead unit of FIG. 1 to increase a read-ahead size when a first read-ahead condition occurs, in accordance with an embodiment of the disclosure.

FIG. 4 illustrates operation of the read-ahead unit to increase a read-ahead size when a second read-ahead condition occurs, in accordance with an embodiment of the disclosure.

FIG. 5 illustrates operation of the read-ahead unit to increase a read-ahead size, in accordance with an embodiment of the disclosure.

FIG. 6 illustrates operation of the read-ahead unit of FIG. 1 to perform a subsequent read-ahead operation based on metadata of read-ahead data, in accordance with an embodiment of the disclosure.

FIG. 7 illustrates a data processing system, to which the data processing system of FIG. 1 is applied, in accordance with an embodiment of the disclosure.

FIG. 8 illustrates a data processing system, to which the data processing system of FIG. 1 is applied, in accordance with an embodiment of the disclosure.

FIG. 9 illustrates a data processing system including a solid state drive (SSD) in accordance with an embodiment.

FIG. 10 illustrates a data processing system including a memory system in accordance with an embodiment.

FIG. 11 illustrates a data processing system including a memory system in accordance with an embodiment.

FIG. 12 illustrates a network system including a memory system in accordance with an embodiment.

FIG. 13 illustrates a nonvolatile memory device included in a memory system in accordance with an embodiment.

FIG. 14 illustrates a process for performing read-ahead operations in accordance with an embodiment.

### DETAILED DESCRIPTION

In the present disclosure, advantages, features and methods for achieving them will become more apparent after a reading of the following exemplary embodiments taken in conjunction with the accompanying drawings. The present disclosure may, however, be embodied in different forms and should not be construed as being limited to the embodiments set forth herein. Rather, these embodiments are provided to describe the present disclosure in detail to the extent that a person skilled in the art to which the disclosure pertains can easily carry out the technical ideas of the present disclosure.

It is to be understood herein that embodiments of the present disclosure are not limited to the particulars shown in the drawings and that the drawings are not necessarily to scale and in some instances proportions may have been exaggerated in order to more clearly depict certain features of the disclosure. While particular terminology is used herein, it is to be appreciated that the terminology used herein is for the purpose of describing particular embodiments only and is not intended to limit the scope of the present disclosure.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a data processing system will be described below with reference to the accompanying drawings through various examples of embodiments.

FIG. 1 illustrates a data processing system 1 in accordance with an embodiment of the disclosure.

The data processing system 1 may include a processing unit 10, an input/output unit 20, and a storage unit 30. In an embodiment, the data processing system 1 includes, for example, a database server, a personal computer, a laptop computer, a smartphone, or the like. In an embodiment, the input/output unit 20 includes digital logic, a microcontroller, an embedded processor, or combinations thereof. In an embodiment, the storage unit 30 includes, for example, an Solid State Disk (SSD), a Hard Disk Drive (HDD), or the like.

The processing unit 10 may obtain and use data, stored in the storage unit 30, through the input/output unit 20. The processing unit 10 may transmit a read request for data to the input/output unit 20 so as to obtain the data stored in the storage unit 30.

In response to the read request received from the processing unit 10, the input/output unit 20 may perform a read operation on the storage unit 30, and may transmit data to the processing unit 10 when the data is received from the storage unit 30. Also, the input/output unit 20 may perform a read-ahead operation on the storage unit 30, based on the read request, before receiving a subsequent read request.

The input/output unit 20 may include a read-ahead unit RAU and a memory MEM. In an embodiment, the read-ahead unit RAU includes digital logic circuits, sequencer circuits, register circuits, a microcontroller, a microprocessor, or combinations thereof and may perform one or more operations by executing firmware. In an embodiment, the memory MEM includes a registers, a random-access memory, a non-volatile memory, a read-only memory, or combinations thereof.

The read-ahead unit RAU may determine whether to perform a read-ahead operation on the storage unit 30, based on a read request received from the processing unit 10. For example, the read-ahead unit RAU may perform the read-ahead operation when it is determined that the read request constitutes a sequential access pattern. On the other hand, the read-ahead unit RAU may not perform the read-ahead operation when it is determined that the read request does not constitute a sequential access pattern.

The read-ahead unit RAU may perform the read-ahead operation on data sequential to data corresponding to a read request. The data sequential to the data corresponding to the read request may be data for which the processing unit 10 is expected to transmit a subsequent read request according to a sequential access pattern.

The data on which the read-ahead operation is completed may be transmitted from the storage unit 30 and be stored in the memory MEM. When the subsequent read request is for the read-ahead data, that is, when a read-ahead hit occurs, the input/output unit 20 may transmit the read-ahead data from the memory MEM to the processing unit 10. When the read-ahead hit occurs, the read-ahead unit RAU may successively perform a subsequent read-ahead operation.

On the other hand, when the subsequent read request is not for the read-ahead data, that is, when a read-ahead miss occurs, the input/output unit 20 may perform a read operation on the storage unit 30 so as to read data corresponding to the subsequent read request. When the read-ahead miss occurs, the read-ahead unit RAU may stop a read-ahead operation.

According to an embodiment, when the read-ahead unit RAU receives a read request for data from the processing unit 10 after a read-ahead operation on the corresponding data is completed, that is, when a first read-ahead condition occurs, the read-ahead unit RAU may increase a read-ahead size and perform a subsequent read-ahead operation based on an increased read-ahead size. The read-ahead size may mean a size of data to be read ahead from the storage unit 30 through a read-ahead operation. The read-ahead size may be increased stepwise by a predetermined size from an initial read-ahead size each time the first read-ahead condition occurs.

According to an embodiment, when the first read-ahead condition occurs, the read-ahead unit RAU may increase the read-ahead size up to a first maximum read-ahead size. That is to say, after being increased up to the first maximum read-ahead size, the read-ahead size may not be increased any more even though the first read-ahead condition occurs again.

According to an embodiment, the read-ahead unit RAU may determine whether the read-ahead operation causes a bottleneck with respect to the processor unit 10. A situation in which the read-ahead operation causes a bottleneck with respect to the processing unit 10 may mean a situation in which a read request for data is received from the processing unit 10 before the read-ahead operation on the corresponding data is completed. A situation in which the read-ahead operation causes a bottleneck with respect to the processing unit 10 may mean a situation in which a read request for data is received from the processing unit 10 before the corresponding data on which the read-ahead operation is performed is transmitted from the storage unit 30 and is stored in the memory MEM. A situation in which the read-ahead operation causes a bottleneck with respect to the processing unit 10 may mean a situation in which a read request for data is received from the processing unit 10 while the storage unit 30 still performs an internal read operation on the corresponding data. A situation in which the read-ahead operation causes a bottleneck with respect to the processing unit 10 may mean a situation in which a data processing speed of the processing unit 10 is faster than a data retrieval speed through the read-ahead operation.

According to an embodiment, when it is determined that the read-ahead operation has caused a bottleneck with respect to the processor unit 10, that is, when a second read-ahead condition occurs, the read-ahead unit RAU may increase a read-ahead size and perform a subsequent read-ahead operation based on an increased read-ahead size.

According to an embodiment, when the second read-ahead condition occurs, the read-ahead unit RAU may increase a read-ahead size up to a second maximum read-ahead size. That is to say, after being increased up to the second maximum read-ahead size, the read-ahead size may not be increased any more even though the second read-ahead condition occurs again. The second maximum read-ahead size may be a maximum size of data which may be outputted to the input/output unit 20 as a plurality of nonvolatile memory devices included in the storage unit 30 perform in parallel internal read operations, respectively.

According to an embodiment, the second maximum read-ahead size may be larger than the first maximum read-ahead size. Therefore, if the second read-ahead condition occurs in a situation in which the read-ahead size is increased up to the first maximum read-ahead size by the first read-ahead condition, the read-ahead unit RAU may additionally increase the read-ahead size up to the second maximum read-ahead size.

In other words, if the read-ahead size is set to be too large, thrashing or contention may occur to degrade the performance of the input/output unit 20. Therefore, the read-ahead size may be increased only up to the first maximum read-ahead size by the first read-ahead condition. However, when the read-ahead operation causes a bottleneck, the read-ahead size may be additionally increased up to the second maximum read-ahead size by the second read-ahead condition. Thus, according to embodiments of the disclosure, a bottleneck situation may be immediately solved, and the performance of the input/output unit 20 may be maintained.

The read-ahead unit RAU may be realized in the form of software, hardware or firmware.

The memory MEM may temporarily store or cache data between the processing unit 10 and the storage unit 30. The memory MEM may store data transmitted from the storage unit 30 as the read-ahead unit RAU performs a read-ahead operation.

According to an embodiment, when data corresponding to a read request of the processing unit 10 is stored in the memory MEM, the input/output unit 20 may not perform a read operation on the storage unit 30 and may transmit the data, stored in the memory MEM, to the processing unit 10. When data corresponding to a read request is not stored in the memory MEM, the input/output unit 20 may perform a read operation on the storage unit 30 and may transmit data, transmitted from the storage unit 30, to the processing unit 10.

According to an embodiment, when data on which a read-ahead operation is to be performed is stored in the memory MEM, the read-ahead unit RAU may not perform the read-ahead operation on the storage unit 30. When data on which a read-ahead operation is to be performed is not stored in the memory MEM, the read-ahead unit RAU may perform the read-ahead operation on the storage unit 30 and may store the data, transmitted from the storage unit 30, in the memory MEM.

The storage unit 30 may store data under the control of the input/output unit 20. When the input/output unit 20 performs a read operation or a read-ahead operation, the storage unit 30 may perform an internal read operation under the control of the input/output unit 20, and may transmit data, read through the internal read operation, to the input/output unit 20.

The storage unit 30 may include a plurality of nonvolatile memory devices (not illustrated). The plurality of nonvolatile memory devices may perform in parallel internal read operations, respectively, under the control of the input/output unit 20.

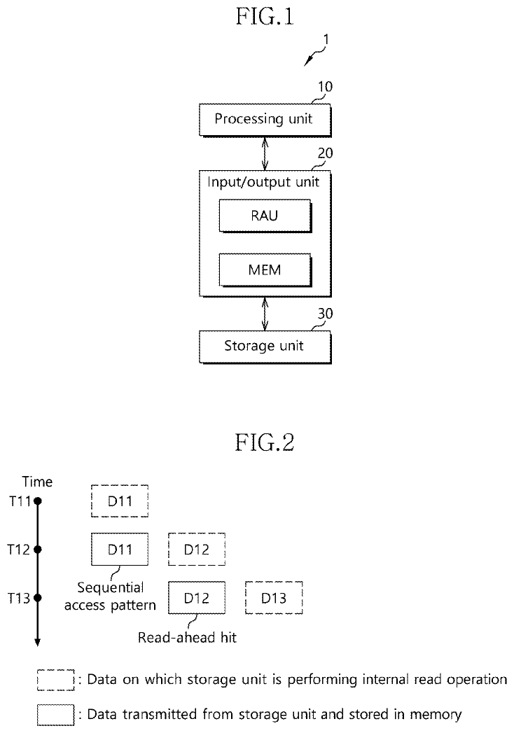

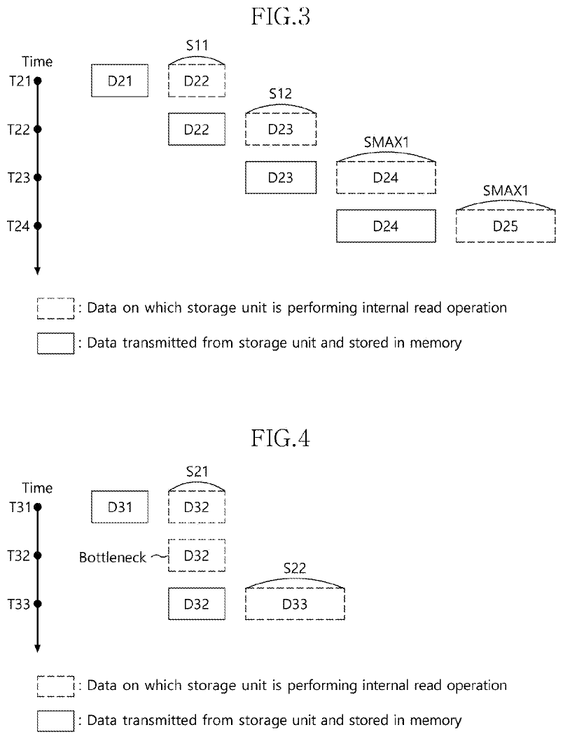

FIG. 2 illustrates operation of the input/output unit 20 of FIG. 1 in accordance with an embodiment of the disclosure.

Referring to FIG. 2, at a time T11, the input/output unit 20 may receive a read request for data D11 from the processing unit 10. The input/output unit 20 may perform a read operation on the data D11 in response to the read request. The storage unit 30 may perform an internal read operation on the data D11 under the control of the input/output unit 20.

At a time T12, the data D11 may be transmitted from the storage unit 30 and be stored in the memory MEM. The input/output unit 20 may transmit the data D11, stored in the memory MEM, to the processing unit 10.

The read-ahead unit RAU may determine whether the read request for the data D11 constitutes a sequential access pattern. When it is determined that the read request for the data D11 constitutes a sequential access pattern, the read-ahead unit RAU may perform a read-ahead operation on data D12 while the data D11 is processed in the processing unit 10. The data D12 may be data sequential to the data D11 according to the sequential access pattern. The storage unit 30 may perform an internal read operation on the data D12 under the control of the read-ahead unit RAU.

According to an embodiment, the read-ahead unit RAU may perform the read-ahead operation on the data D12 in parallel with the transmission of the data D11 from the memory MEM to the processing unit 10.

At a time T13, the data D12 may be transmitted from the storage unit 30 and be stored in the memory MEM. The input/output unit 20 may receive a read request for the data D12 from the processing unit 10. The input/output unit 20 may transmit the data D12 stored in the memory MEM to the processing unit 10 in response to the read request. The read-ahead unit RAU may determine that a read-ahead hit has occurred for the data D12, and may perform a read-ahead operation on data D13. The data D13 may be data sequential to the data D12 according to the sequential access pattern. The storage unit 30 may perform an internal read operation on the data D13 under the control of the read-ahead unit RAU.

In summary, the input/output unit 20 may perform a read-ahead operation on data for which a subsequent read request is expected to be received from the processing unit 10, and, when the subsequent read request for the data is actually received, may immediately transmit the read-ahead data to the processing unit 10. Therefore, the processing unit 10 does not need to wait for a time during which the storage unit 30 performs an internal read operation on data.

FIG. 3 illustrates operation of the read-ahead unit RAU of FIG. 1 to increase a read-ahead size when a first read-ahead condition occurs, in accordance with an embodiment of the disclosure.

Referring to FIG. 3, at a time T21, it is assumed that, while data D21 is processed in the processing unit 10, the read-ahead unit RAU performs a read-ahead operation on data D22 since a sequential access pattern or a read-ahead hit is satisfied. The data D22 may correspond to a read-ahead size S11.

At a time T22, the data D22 may be transmitted from the storage unit 30 and be stored in the memory MEM. The input/output unit 20 may receive a read request for the data D22 from the processing unit 10 after the read-ahead operation on the data D22 is completed. The input/output unit 20 may transmit the data D22, stored in the memory MEM, to the processing unit 10 in response to the read request for the data D22. Since the read-ahead unit RAU receives the read request for the data D22 from the processing unit 10 after the read-ahead operation on the data D22 is completed, the read-ahead unit RAU may determine that the first read-ahead condition has occurred, and may perform a read-ahead operation on data D23 having an increased read-ahead size S12.

At a time T23, the data D23 may be transmitted from the storage unit 30 and be stored in the memory MEM. The input/output unit 20 may receive a read request for the data D23 from the processing unit 10 after the read-ahead operation on the data D23 is completed. The input/output unit 20 may transmit the data D23, stored in the memory MEM, to the processing unit 10 in response to the read request for the data D23. Since the read-ahead unit RAU receives the read request for the data D23 from the processing unit 10 after the read-ahead operation on the data D23 is completed, the read-ahead unit RAU may determine that the first read-ahead condition has occurred, and may perform a read-ahead operation on data D24 having an increased read-ahead size SMAX1. The increased read-ahead size SMAX1 may be the first maximum read-ahead size.

At a time T24, the data D24 may be transmitted from the storage unit 30 and be stored in the memory MEM. The input/output unit 20 may receive a read request for the data D24 from the processing unit 10 after the read-ahead operation on the data D24 is completed. The input/output unit 20 may transmit the data D24, stored in the memory MEM, to the processing unit 10 in response to the read request for the data D24. The read-ahead unit RAU may determine that a read-ahead hit has occurred for the data D24, and may perform a read-ahead operation on data D25 having the first maximum read-ahead size SMAX1. Namely, the read-ahead unit RAU may not increase any more the read-ahead size SMAX1.

FIG. 4 illustrates operation of the read-ahead unit RAU to increase a read-ahead size when a second read-ahead condition occurs, in accordance with an embodiment of the disclosure.

Referring to FIG. 4, at a time T31, it is assumed that, while data D31 is processed in the processing unit 10, the read-ahead unit RAU performs a read-ahead operation on data D32 since a sequential access pattern or a read-ahead hit is satisfied. The data D32 may correspond to a read-ahead size S21.

At a time T32, the input/output unit 20 may receive a read request for the data D32 from the processing unit 10 before the read-ahead operation on the data D32 is completed. The storage unit 30 may still be performing an internal read operation on the data D32. Therefore, the processing unit 10 needs to wait until the internal read operation of the storage unit 30 is completed. That is to say, the read-ahead operation on the data D32 may cause a bottleneck with respect to the processing unit 10.

At a time T33, the data D32 may be transmitted from the storage unit 30 and be stored in the memory MEM. The input/output unit 20 may transmit the data D32, stored in the memory MEM, to the processing unit 10. Since the read-ahead unit RAU receives the read request for the data D32 from the processing unit 10 before the read-ahead operation on the data D32 is completed, the read-ahead unit RAU may determine that the second read-ahead condition has occurred, and may perform a read-ahead operation on data D33 having an increased read-ahead size S22. As described above, when the second read-ahead condition occurs, the read-ahead unit RAU may increase a read-ahead size up to the second maximum read-ahead size.

According to an embodiment, after increasing a read-ahead size due to the second read-ahead condition, if it is determined that the second read-ahead condition does not occur anymore and the first read-ahead condition occurs, the read-ahead unit RAU may reduce a read-ahead size to a predetermined size. In other words, after increasing the read-ahead size in a bottleneck situation, the read-ahead unit RAU may reduce a read-ahead size when it is determined that the bottleneck has been solved.

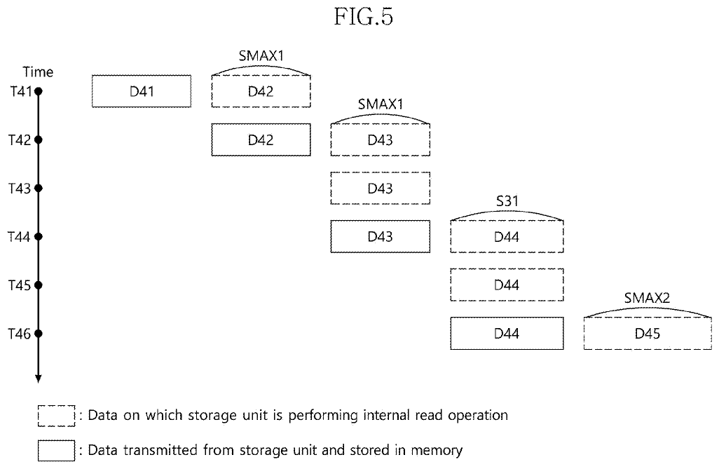

FIG. 5 illustrates operation of the read-ahead unit RAU to increase a read-ahead size, in accordance with an embodiment of the disclosure.

Referring to FIG. 5, at a time T41, it is assumed that, while data D41 is processed in the processing unit 10, the read-ahead unit RAU performs a read-ahead operation on data D42 since a sequential access pattern or a read-ahead hit is satisfied. Also, it is assumed that a read-ahead size is increased up to a first maximum read-ahead size SMAX1 by the first read-ahead condition.

At a time T42, the data D42 may be transmitted from the storage unit 30 and be stored in the memory MEM. The input/output unit 20 may receive a read request for the data D42 from the processing unit 10 after the read-ahead operation on the data D42 is completed. The input/output unit 20 may transmit the data D42, stored in the memory MEM, to the processing unit 10 in response to the read request for the data D42. The read-ahead unit RAU may determine that a read-ahead hit has occurred for the data D42, and may perform a read-ahead operation on data D43 having the first maximum read-ahead size SMAX1. The first maximum read-ahead size SMAX1 may not be increased any more.

At a time T43, the input/output unit 20 may receive a read request for the data D43 from the processing unit 10 before the read-ahead operation on the data D43 is completed. The storage unit 30 may still be performing an internal read operation on the data D43.

At a time T44, the data D43 may be transmitted from the storage unit 30 and be stored in the memory MEM. The input/output unit 20 may transmit the data D43, stored in the memory MEM, to the processing unit 10. The read-ahead unit RAU may determine that the second read-ahead condition has occurred for the data D43, and may perform a read-ahead operation on data D44 having an increased read-ahead size S31. Namely, a read-ahead size may be additionally increased by the second read-ahead condition even after being increased up to the first maximum read-ahead size SMAX1 by the first read-ahead condition.

At a time T45, the input/output unit 20 may receive a read request for the data D44 from the processing unit 10 before the read-ahead operation on the data D44 is completed. The storage unit 30 may still be performing an internal read operation on the data D44.

At a time T46, the data D44 may be transmitted from the storage unit 30 and be stored in the memory MEM. The input/output unit 20 may transmit the data D44, stored in the memory MEM, to the processing unit 10. The read-ahead unit RAU may determine that the second read-ahead condition has occurred for the data D44, and may perform a read-ahead operation on data D45 having an increased read-ahead size SMAX2. The increased read-ahead size SMAX2 may be a second maximum read-ahead size. Therefore, even though the second read-ahead condition occurs again for the data D45, the read-ahead size SMAX2 may not be increased any more.

According to an embodiment, after increasing a read-ahead size, due to the second read-ahead condition, to be larger than the first maximum read-ahead size SMAX1, if it is determined that the second read-ahead condition does not occur anymore and the first read-ahead condition has occurred, the read-ahead unit RAU may reduce a read-ahead size to the first maximum read-ahead size SMAX1.

While FIG. 5 illustrates that the read-ahead unit RAU has increased a read-ahead size twice from the first maximum read-ahead size SMAX1 to the second maximum read-ahead size SMAX2, it is to be noted that, according to an embodiment, the read-ahead unit RAU may increase a read-ahead size three or more times from the first maximum read-ahead size SMAX1 to the second maximum read-ahead size SMAX2. According to an embodiment, the read-ahead unit RAU may not increase a read-ahead size stepwise from the first maximum read-ahead size SMAX1 to the second maximum read-ahead size SMAX2, but increase a read-ahead size at a time from the first maximum read-ahead size SMAX1 to the second maximum read-ahead size SMAX2.

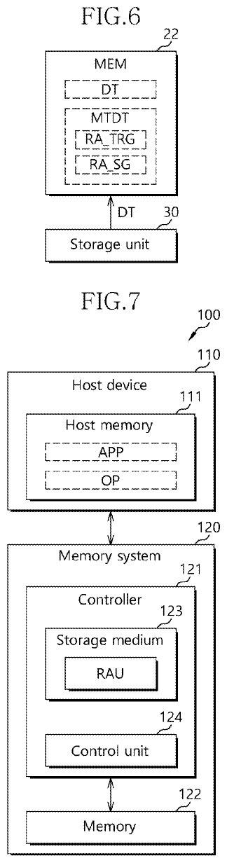

FIG. 6 illustrates operation of the read-ahead unit RAU of FIG. 1 to perform a subsequent read-ahead operation based on metadata MTDT of read-ahead data DT, in accordance with an embodiment of the disclosure.

Referring to FIG. 6, in some cases the read-ahead unit RAU decides to perform a read-ahead operation on data DT and instructs the storage unit 30 to perform an internal read operation on the data DT. The read-ahead data DT may be output from the storage unit 30 and be stored in the memory MEM.

The read-ahead unit RAU may store metadata MTDT corresponding to the data DT in the memory MEM. The metadata MTDT may include a read-ahead trigger RA_TRG and a read-ahead size RA_SG. The read-ahead trigger RA_TRG may be for indicating that the data DT is data which is read in advance through a read-ahead operation. Also, the read-ahead trigger RA_TRG may be for triggering a subsequent read-ahead operation.

The read-ahead unit RAU may store the metadata MTDT in the memory MEM when starting the read-ahead operation on the data DT. The read-ahead unit RAU may store the metadata MTDT in the memory MEM when deciding to perform the read-ahead operation on the data DT and instructing the storage unit 30 to perform the internal read operation on the data DT. That is to say, the read-ahead unit RAU may store the metadata MTDT in the memory MEM before the read-ahead operation on the data DT is completed.

When a read request for the data DT is received from the processing unit 10, the read-ahead unit RAU may determine whether the read-ahead trigger RA_TRG is set, by referring to the metadata MTDT. The read-ahead unit RAU may determine that a read-ahead hit has occurred, when the read-ahead trigger RA_TRG is set in the metadata MTDT.

When the read request for the data DT is received from the processing unit 10 after the read-ahead operation on the data DT is completed, if the read-ahead trigger RA_TRG is set in the metadata MTDT, the read-ahead unit RAU may determine that the first read-ahead condition has occurred. The read-ahead unit RAU may increase the read-ahead size RA_SG, and may perform a subsequent read-ahead operation based on an increased read-ahead size.

When the read request for the data DT is received from the processing unit 10 before the read-ahead operation on the data DT is completed, if the read-ahead trigger RA_TRG is set in the metadata MTDT, the read-ahead unit RAU may determine that the second read-ahead condition has occurred and may therefore increase the read-ahead size RA_SG, and may perform a subsequent read-ahead operation based on the increased read-ahead size.

According to an embodiment, the data DT may be constituted by a plurality of data blocks. The plurality of data blocks may be ones which are read through sequential accesses. In this case, the read-ahead unit RAU may generate the metadata MTDT for each of the plurality of data blocks. The read-ahead unit RAU may generate the metadata MTDT including the read-ahead trigger RA_TRG and the read-ahead size RA_SG for a data block which most precedes (for example, that has the lowest address among the data blocks, or that would be the earliest of the data blocks received from the storage unit) among the plurality of data blocks.

FIG. 7 is a block diagram illustrating a data processing system 100, to which the data processing system 1 of FIG. 1 is applied, in accordance with an embodiment of the disclosure.

Referring to FIG. 7, the data processing system 100 as an electronic system capable of processing data may include a personal computer, a laptop computer, a smartphone, a tablet computer, a digital camera, a game console, a navigation, a virtual reality device, a wearable device, or the like.

The data processing system 100 may include a host device 110 and a memory system 120.

The host device 110 may operate according to an application program APP and an operating system OP. The application program APP and the operating system OP may be stored and executed in a host memory 111. The application program APP may manage data by allocating a file address to the data. The operating system OP may manage data by converting a file address, allocated by the application program APP, into a logical address. The operating system OP may store and manage data, allocated with a logical address, in the memory system 120 according to a request of the application program APP.

The memory system 120 may be configured to store data provided from the host device 110, in response to a write request of the host device 110. Also, the memory system 120 may be configured to provide stored data to the host device 110 in response to a read request of the host device 110.

The memory system 120 may include a Personal Computer Memory Card International Association (PCMCIA) card, a compact flash (CF) card, a smart media card, a memory stick, a multimedia card in the form of an MMC, an eMMC, an RS-MMC and an MMC-micro, a secure digital card in the form of an SD, a mini-SD and a micro-SD, a universal flash storage (UFS), or a solid state drive (SSD).

The memory system 120 may include a controller 121 and a storage medium 122.

The controller 121 may control the storage medium 122 to perform a foreground operation according to an instruction of the host device 110. The foreground operation may include operations of storing data in the storage medium 122 and reading data from the storage medium 122 according instructions, that is, a write request and a read request, of the host device 110.

Further, the controller 121 may control the storage medium 122 to perform a background operation that is internally required, independently of the host device 110. The background operation may include a wear leveling operation, a garbage collection operation, an erase operation, a read reclaim operation and a refresh operation for the storage medium 122. Like the foreground operation, the background operation may include operations of storing data in the storage medium 122 and reading data from the storage medium 122.

The controller 121 may include a control unit 123 and a memory 124.

The control unit 123 may control general operations of the controller 121. The control unit 123 may manage data by receiving a logical address corresponding to the data from the host device 110 and mapping the logical address to a physical address of the storage medium 122. The physical address may indicate a location where the data is stored in the storage medium 122. In other words, a logical address may be an address used by the operating system OP of the host device 110 to access the memory system 120, and a physical address may be an address used by the controller 121 to access the storage medium 122.

The control unit 123 may include a read-ahead unit RAU. When receiving a read request from the host device 110, the read-ahead unit RAU may determine whether the read request constitutes a sequential access pattern, based on a logical address included in the read request. For example, when one or more logical addresses included in the read request are sequential, the read-ahead unit RAU may determine that the read request constitutes a sequential access pattern.

The read-ahead unit RAU may perform a read-ahead operation on the storage medium 122 in substantially the same method as the read-ahead unit RAU of FIG. 1. In this case, the controller 121 may correspond to the input/output unit 20 of FIG. 1, and the host device 110 may correspond to the processing unit 10 of FIG. 1.

The memory 124 may serve as a working memory, a buffer memory or a cache memory of the controller 121. The memory 124 as a working memory may store software programs and various program data to be driven by the controller 121. The memory 124 as a buffer memory may buffer data to be transmitted between the host device 110 and the storage medium 122. The memory 124 as a cache memory may temporarily store cache data. The memory 124 may correspond to the memory MEM of FIG. 1.

The storage medium 122 may store data transmitted from the controller 121 and may transmit stored data to the controller 121, under the control of the controller 121. The storage medium 122 may correspond to the storage unit 30 of FIG. 1.

The storage medium 122 may include one or more nonvolatile memory devices. A nonvolatile memory device may include a flash memory device such as a NAND flash or a NOR flash, an FeRAM (ferroelectric random access memory), a PCRAM (phase-change random access memory), an MRAM (magnetic random access memory) or an ReRAM (resistive random access memory).

Also, a nonvolatile memory device may include one or more planes, one or more memory chips, one or more memory dies or one or more memory packages.

When the storage medium 122 includes a plurality of nonvolatile memory devices, the controller 121 may access the plurality of nonvolatile memory devices in parallel in an interleaving scheme. Thus, the plurality of nonvolatile memory devices may perform in parallel internal operations, for example, internal read operations, respectively. The second maximum read-ahead size SMAX2 described above may be a maximum size of data which may be provided to the controller 121 as the plurality of nonvolatile memory devices included in the storage medium 122 perform in-parallel internal read operations.

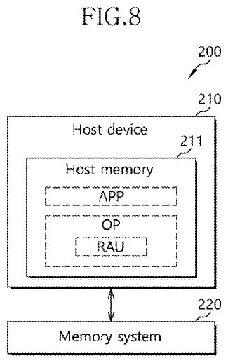

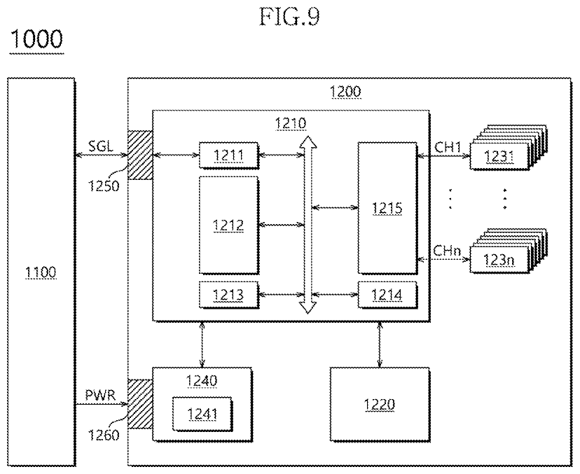

FIG. 8 is a block diagram illustrating a representation of an example of a data processing system 200, to which the data processing system 1 of FIG. 1 is applied, in accordance with an embodiment of the disclosure.

Referring to FIG. 8, the data processing system 200 may include a host device 210 and a memory system 220. An operating system OP of the host device 210 may include a read-ahead unit RAU.

When receiving a read request from an application program APP, the read-ahead unit RAU may determine whether the read request constitutes a sequential access pattern, based on a file address included in the read request. For example, when one or more file addresses included in the read request are sequential, the read-ahead unit RAU may determine that the read request constitutes a sequential access pattern.

The read-ahead unit RAU may perform a read-ahead operation on the memory system 220 in substantially the same method as the read-ahead unit RAU of FIG. 1. In this case, the application program APP may correspond to the processing unit 10 of FIG. 1, the operating system OP may correspond to the input/output unit 20 of FIG. 1, and the memory system 220 may correspond to the storage unit 30 of FIG. 1.

FIG. 9 is a diagram illustrating a data processing system 1000 including a solid state drive (SSD) 1200 in accordance with an embodiment. Referring to FIG. 9, the data processing system 1000 may include a host device 1100 and the SSD 1200.

The host device 1100 may be configured by the host device 110 shown in FIG. 7 or the host device 210 shown in FIG. 8.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS).

The control unit 1212 may analyze and process the signal SGL received from the host device 1100. The control unit 1212 may control operations of internal function blocks according to a firmware or a software for driving the SSD 1200. The random access memory 1213 may be used as a working memory for driving such a firmware or software.

The control unit 1212 may be configured in the same manner as the control unit 123 shown in FIG. 7. The control unit 1212 may include the read-ahead unit RAU shown in FIG. 7.

The ECC unit 1214 may generate the parity data of data to be transmitted to at least one of the nonvolatile memory devices 1231 to 123n. The generated parity data may be stored together with the data in the nonvolatile memory devices 1231 to 123n. The ECC unit 1214 may detect an error of the data read from at least one of the nonvolatile memory devices 1231 to 123n, based on the parity data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

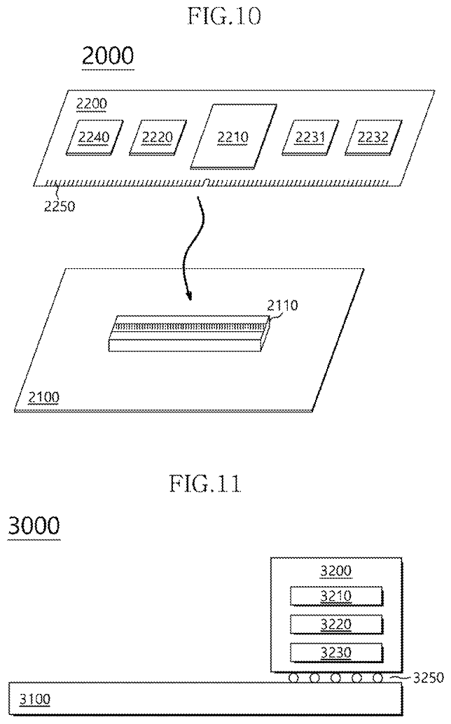

FIG. 10 is a diagram illustrating a data processing system 2000 including a memory system 2200 in accordance with an embodiment. Referring to FIG. 10, the data processing system 2000 may include a host device 2100 and the memory system 2200.

The host device 2100 may be configured in the form of a board such as a printed circuit board. Although not shown, the host device 2100 may include internal function blocks for performing the function of a host device. The host device 2100 may be configured by the host device 110 shown in FIG. 7 or the host device 210 shown in FIG. 8.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 9.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

FIG. 11 is a diagram illustrating a data processing system 3000 including a memory system 3200 in accordance with an embodiment. Referring to FIG. 11, the data processing system 3000 may include a host device 3100 and the memory system 3200.

The host device 3100 may be configured in the form of a board such as a printed circuit board. Although not shown, the host device 3100 may include internal function blocks for performing the function of a host device. The host device 3100 may be configured by the host device 110 shown in FIG. 7 or the host device 210 shown in FIG. 8.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 9.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

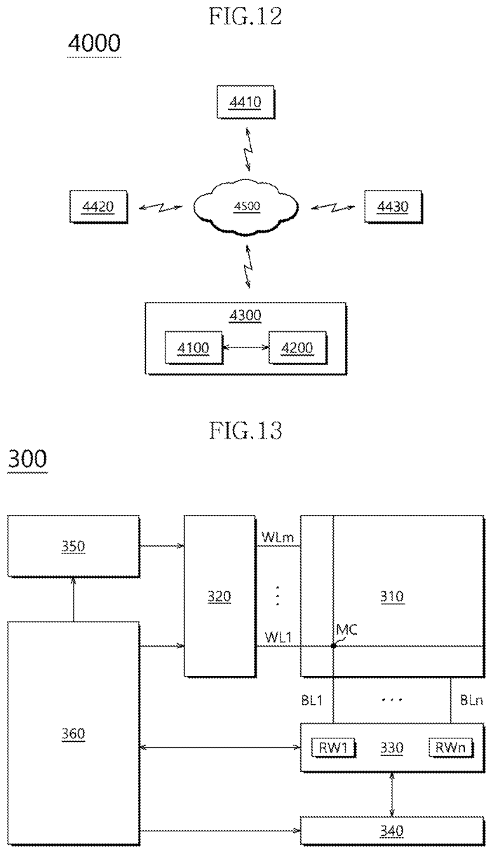

FIG. 12 is a diagram illustrating a network system 4000 including a memory system 4200 in accordance with an embodiment. Referring to FIG. 12, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 120 shown in FIG. 7, the memory system 220 shown in FIG. 8, the memory system 1200 shown in FIG. 9, the memory system 2200 shown in FIG. 10 or the memory system 3200 shown in FIG. 11.

FIG. 13 is a block diagram illustrating a nonvolatile memory device 300 included in a memory system in accordance with an embodiment. Referring to FIG. 13, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

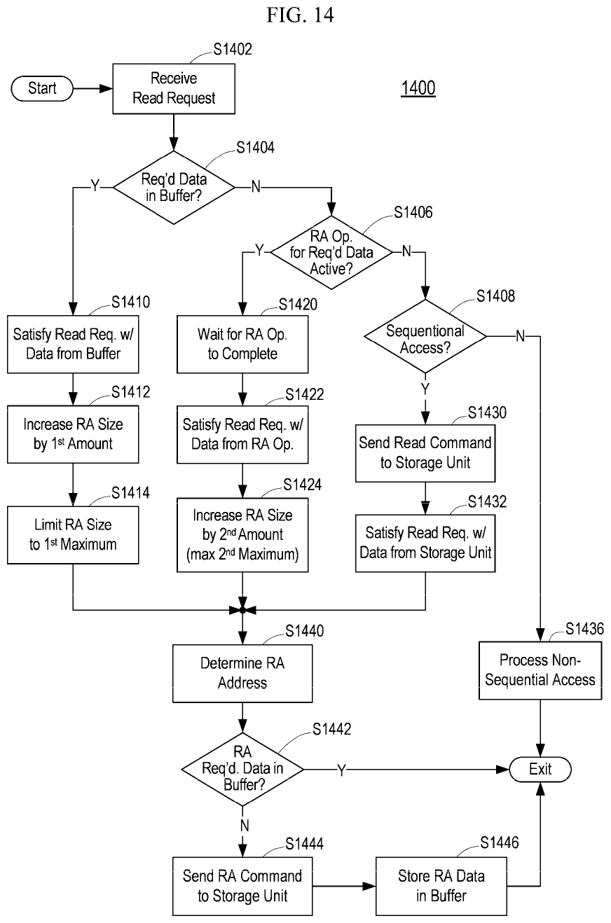

FIG. 14 illustrates a process 1400 for performing read-ahead operations in accordance with an embodiment. The process 1400 may be performed by an input/output unit such as the input/output unit 20 of FIG. 1.

At S1402, the process 1400 receives a read request that requests data.

At S1404, the process 1400 determines whether the requested data is in the buffer memory. This may be performed using, for example, a caching algorithm and corresponding circuits and/or data structures, or by other means of the related arts. If the process 1400 determines that the requested data is in the buffer memory, at S1404 the process 1400 proceeds to S1410; otherwise, the process 1400 proceeds to S1406.

At S1406, the process 1400 determines whether the requested data is in the process of being obtained from a storage unit by an active read-ahead (RA) operation. This may be performed by, for example, comparing the address of the read request to an address of the active RA operation. If the process 1400 determines that the requested data is being obtained by the active RA operation, at S1406 the process 1400 proceeds to S1420; otherwise, the process 1400 proceeds to S1408.

At S1408, the process 1400 determines whether the read request is a sequential access, that is, that the read is part of a sequential access pattern. This determination may be performed using, for example, a sequential access indication in the read request, or analysis of previous read requests. If the process 1400 determines that the requested data is a sequential access, at S1408 the process 1400 proceeds to S1430; otherwise, the process 1400 proceeds to S1436.

At S1410, which may correspond to a read-ahead hit, the process 1400 satisfies the read request by sending the data requested by the read request and found in the buffer memory back to the source of the read request.

At S1412, when a first RA condition, such as a RA hit, has occurred, the process 1400 may increase an RA size by a first step amount. In an embodiment, the first RA condition has occurred when the requested data was found in the buffer memory.

In another embodiment, first RA condition has occurred when the requested data was found in the buffer memory and an RA trigger indication in metadata associated with the requested data in the buffer memory indicates that the data was stored in the buffer memory by an RA operation, and has not occurred when the RA trigger indication in the metadata does not indicate that the data was stored in the buffer memory by an RA operation.

In an embodiment, the RA size increased at S1412 may be determined using an RA size indication stored in the metadata associated with the requested data in the buffer memory.

At S1414, the process 1400 limits the read-ahead size to a first maximum RA size. That is, if the read-ahead size is greater than the first maximum RA size, the process 1400 sets the read-ahead size to be equal to the first maximum RA size. The process 1400 then proceeds to S1440.

At S1420, which may correspond to a read-ahead bottleneck occurring, the process 1400 waits for the active RA operation that is obtaining the requested data to complete before proceeds to S1422.

At S1422, the process 1400 satisfies the read request by sending the data requested by the read request and obtained by the active RA operation back to the source of the read request. In an embodiment, the process 1400 also stores the data obtained by the active RA operation into the buffer memory.

At S1424, the process 1400 may determine that a second RA condition, such as an RA bottleneck condition, has occurred because the read request arrived before the RA operation had obtained the requested data. In response to the second RA condition having occurred, the process 1400 increases the RA size by a second step amount, but limited to a second maximum RA size. That is, if the read-ahead size becomes greater than the second maximum RA size, the process 1400 sets the read-ahead size to be equal to the second maximum RA size. The process 1400 then proceeds to S1440. In an embodiment, the second maximum RA size is greater than the first maximum RA size.

In an embodiment, when the read-ahead size is equal to the first maximum RA size, at S1424, when the second RA condition has occurred, the process 1400 sets the read-ahead size to be equal to the second maximum RA size.

At S1430, the process 1400 generates a read command to obtain the requested data, and sends the read command to the storage unit.

At S1432, when the storage unit returns the requested data in response to the read command, the process 1400 satisfies the read request by sending the data returned from the storage unit back to the source of the read request.

At S1436, the process 1400, the read request is processed as a non-sequential access. Processing the read request as a non-sequential access may include satisfying the read request with data from the buffer when the requested data is in the buffer, satisfying the read request with data from an RA operation that was in the process of being performed when the read request was received, satisfying the read request with data from the storage unit, or combinations thereof. The process 1400 then exits.

At S1440, the process 1400 determines an address of a RA operation to be performed. The address of the RA operation to be performed may be determined by, for example, adding a size of a previously performed read request or read-ahead operation to an address of the previously performed read request or read-ahead operation, by adding a previously-determined stride to an address of the previously performed read request or read-ahead operation, or by other techniques of the related arts.

At S1442, the process 1400 determines whether the data that the read-ahead operation is to obtain is already in the buffer memory. This may be performed in the same manner as in S1404. If the process 1400 determines that the read-ahead operation is to obtain is already in the buffer memory, at S1442 the process 1400 exits; otherwise, the process 1400 proceeds to S1444.

At S1444, the process 1400 issues an RA command to the storage unit using the RA address and the RA size.

In an embodiment, at S1444 the process 1400 sets an RA trigger indication in metadata associated with the data that will be obtained by RA operation. The metadata may be stored in the buffer memory.

In an embodiment, at S1444 the process 1400 sets an RA size indication in the metadata associated with the data that will be obtained by RA operation.

At S1446, when the RA command completes, the process 1400 stores the data obtained from the storage unit by the RA command in the buffer memory.

While various embodiments have been described above, it will be understood to those skilled in the art that the embodiments described are examples only. Accordingly, the data processing system described herein should not be limited based on the described embodiments.

What is claimed is:

1. A data processing system comprising:
a storage unit; and
an input/output unit configured to perform a read-ahead operation on first data stored in the storage unit according to a read-ahead size,
wherein the input/output unit performs a determination of whether the read-ahead operation causes a bottleneck with respect to a processing unit, and adjusts the read-ahead size depending on a result of the determination.

2. The data processing system according to claim 1, wherein the input/output unit determines that the read-ahead operation causes the bottleneck when a read request for the first data is received from the processing unit before the read-ahead operation is completed.

3. The data processing system according to claim 1, wherein when the input/output unit determines that the read-ahead operation causes the bottleneck, the input/output unit increases the read-ahead size and performs a subsequent read-ahead operation on second data according to the increased read-ahead size.

4. The data processing system according to claim 3,
wherein when the input/output unit increases the read-ahead size, the read-ahead size is limited by a maximum read-ahead size, and
wherein the maximum read-ahead size is a maximum size of data capable of being provided to the input/output unit by a plurality of memory devices included in the storage unit and respectively performing internal read operations in parallel.

5. The data processing system according to claim 4,
wherein the maximum read-ahead size is a second maximum read-ahead size,
wherein the input/output unit increases the read-ahead size up to a size limited by a first maximum read-ahead size when a read request for the first data is received from the processing unit after the read-ahead operation is completed, and
is wherein the second maximum read-ahead size is larger than the first maximum read-ahead size.

6. The data processing system according to claim 1, wherein the input/output unit stores a read-ahead trigger indication and a read-ahead size indication corresponding to the read-ahead size in a memory when performing the read-ahead operation, and performs a subsequent read-ahead operation on second data by referring to the read-ahead trigger indication and the read-ahead size indication in response to a read request for the first data being received from the processing unit.

7. The data processing system according to claim 1, wherein the input/output unit starts the read-ahead operation before receiving a read request for the first data from the processing unit, receives the first data from the storage unit and stores the first data in a memory by performing the read-ahead operation, and transmits the first data from the memory to the processing unit in response to the read request.

8. A data processing system comprising:
a storage unit; and
an input/output unit configured to:
store metadata in a memory when performing a read-ahead operation on first data stored in the storage unit, and
perform a subsequent read-ahead operation on second data based on the metadata when a read request for the first data is received from a processing unit before the read-ahead operation is completed.

9. The data processing system according to claim 8,
wherein the metadata includes a read-ahead trigger, and
wherein the input/output unit determines, by checking the read-ahead trigger, that the read-ahead operation is not completed when the read request is received from the processing unit before the first data is stored in the memory.

10. The data processing system according to claim 8,
wherein the metadata includes a read-ahead size, and
wherein, when the read request is received from the processing unit before the read-ahead operation is completed, the input/output unit increases the read-ahead size and performs the subsequent read-ahead operation based on the increased read-ahead size.

11. The data processing system according to claim 10,
wherein the input/output unit increases the read-ahead size up to a size limited by a maximum read-ahead size, and
wherein the maximum read-ahead size is a maximum size of data capable of being outputted to the input/output unit by a plurality of nonvolatile memory devices included in the storage unit and respectively performing internal read operations in parallel.

12. The data processing system according to claim 11,
wherein the maximum read-ahead size is a second maximum read-ahead size,
wherein the input/output unit increases the read-ahead size up to a size limited by a first maximum read-ahead size when the read request is received from the processing unit after the read-ahead operation is completed, and
wherein the second maximum read-ahead size is larger than the first maximum read-ahead size.

13. The data processing system according to claim 8, wherein the input/output unit starts the read-ahead operation before receiving the read request from the processing unit, receives the first data from the storage unit and stores the first data in the memory by performing the read-ahead operation, and transmits the first data from the memory to the processing unit in response to the read request.

14. A method for operating a data processing system including a storage unit and an input/output unit, the method comprising:
performing a read-ahead operation on first data stored in the storage unit; and
increasing a read-ahead size up to a size limited according to a read-ahead condition, the read-ahead size being increased up to a first maximum read-ahead size when a first read-ahead condition occurs, the read-ahead size being increased up to a second maximum read-ahead size larger than the first maximum read-ahead size when a second read-ahead condition occurs.

15. The method of claim 14, wherein the input/output unit determines that the first read-ahead condition has occurred when a read request for the first data is received from a processing unit after the read-ahead operation is completed.

16. The method of claim 14, wherein the input/output unit determines that the second read-ahead condition has occurred when a read request for the first data is received from a processing unit before the read-ahead operation is completed.

17. The method of claim 14, wherein the input/output unit increases the read-ahead size and performs a subsequent read-ahead operation on second data stored in the storage unit based on the increased read-ahead size.

18. The method of claim 14, wherein the second maximum read-ahead size is a maximum size of data capable of being outputted to the input/output unit by a plurality of nonvolatile memory devices included in the storage unit and performing respective internal read operations in parallel.

19. The method of claim 14, wherein the input/output unit stores a read-ahead trigger in a memory when performing the read-ahead operation, and determines whether the first read-ahead condition or the second read-ahead condition occurs by referring to the read-ahead trigger when a read request for the first data is received from a processing unit.

20. The method of 14, wherein the input/output unit starts the read-ahead operation before receiving a read request for the first data from a processing unit, receives the first data from the storage unit and stores the first data in a memory by performing the read-ahead operation, and transmits the first data from the memory to the processing unit in response to the read request.
